(19) United States
(12) Patent Application Publication
(10) Pub. No.: US 2008/0177671 A1
(43) Pub. Date: Jul. 24, 2008

(54) Accelerated depreciation of separated assets with valuation guidance based on electronic market survey of electronic web and non-web marketplaces, tiny simple application (called a T-sap) used with a Real Estate Web Platform to provide intelligent guidance to investors to maximize their returns by enabling them to use tiny- simple applications that can be used standalone or mixed and matched.

(76) Inventors: Narinder Pal Sandhu, Fremont, CA (US); Pankaj Ashwin Shukla, Fremont, CA (US)

Correspondence Address: FURR LAW FIRM, 2622 DEBOLT ROAD, UTICA, OH, 43080, US

(21) Appl. No.: 11/625,814

(22) Filed: Jan. 22, 2007

(51) Int. Cl. G06Q 40/00

(52) U.S. Cl. 705/36 R

(57) ABSTRACT

The current invention is a system and a destination web site that will serve the needs of Real Estate investors in a unique way. The system has an Accelerated Depreciation of separated assets with valuation guidance tiny simple application for a real estate web application platform that serves unique functions that solve the pain points of real estate investors.

An accelerated depreciation of separated assets with valuation guidance based on electronic market survey of electronic web and non-web marketplaces, tiny simple application (called a T-sap) used with a Real Estate Web Platform to provide intelligent guidance to investors to maximize their returns by enabling them to use tiny-simple applications that can be used standalone or mixed and matched.

### CROSS-REFERENCES TO RELATED APPLICATIONS (IF ANY)

None

### STATEMENT AS TO RIGHTS TO INVENTIONS MADE UNDER FEDERALLY-SPONSORED RESEARCH AND DEVELOPMENT (IF ANY)

None

### BACKGROUND OF INVENTION

1. Field of the Invention

The present invention is directed to a method of assisting real estate investors in their investments to maximize their returns, more particularly an accelerated depreciation of separated assets with valuation guidance tiny simple application (T-sap) for a real estate web application platform. The platform supports web applications that have inbuilt intelligence to guide an investor. Each T-sap operates independently or in combination to meet customer needs and automatically recommends other web T-sap in accord with customer needs. The platform will enable different modes of input devices for interaction such as keyboard, touch-screen, fax, audio, cell phones, pda, etc. and will output information on appropriate displays such as video terminals, e-mail, fax, audio, cell phones etc. (page has a great description of output devices. The platform will also enable collaboration for those who seek assistance through technology.

2. Background

With the world moving at a faster and faster pace and with all the changes with technology and Internet, a real estate investor needs every tool that they can have available. But every investor is different and needs a different set of tools and options that an investor can optimize for their own use especially when dealing with accelerated depreciation.

Currently in the market there are products that aggregate the pain points of Real Estate investors to use a monolithic application which are mostly desktop applications. Therefore critical pain points are not served.

There exists a need for a web real estate platform that will store their applicable information and will allow them to add T-sap when necessary with the data being leveraged from the current T-saps being used to new T-saps that investor starts using and providing a seamless experience between current T-sap and T-sap that investor is using.

### PRIOR ART

U.S. Pat. No. 7,076,452 by Florance, et al. and issued on Jul. 11, 2006, is for a System and method for collection, distribution, and use of information in connection with commercial real estate.

United States Patent Application 20030126052 by Rademaekers, et al. and published on Jul. 3, 2003, is for a Method and apparatus for establishing real estate investments. It discloses a system, method, apparatus, computer program code and means for establishing a real estate investment which include receiving information identifying a user responsible for a new real estate investment, receiving information identifying the new real estate investment, monitoring the received information identifying the new real estate investment for information triggering a trigger event, and causing the transmission, when the triggering event is detected, of a notification message to a designated recipient.

United States Patent Application 20020046159 by Raveis and published on Apr. 18, 2002, is for a System and method for managing transactions relating to real estate. It discloses a system and method for managing real estate transactions. The method includes the steps of receiving and storing data relating to a plurality of contacts including buyers and sellers of real estate, receiving and storing data relating to a plurality of vendors each associated with at least one phase of a real estate transaction, accessing vendor data based upon occurrence of a particular phase of the real estate transaction and communicating data relating to the vendors to a contact upon occurrence of the particular phase of the real estate transaction.

United States Patent Application 20020010674 by Kent and published on Jan. 24, 2002, is for a Method of providing tax credits and property rental and purchase.

There exists a need to get better results. There is still room for improvement in the art.

### SUMMARY OF THE INVENTION

The current invention is an accelerated depreciation of separated assets with valuation guidance tiny simple application (T-sap) for a real estate web application platform that will serve the needs of Real Estate investors in a unique way. The platform supports a T-sap that have inbuilt intelligence to guide an investor when dealing with accelerated depreciation issues. Each T-sap operates independently or in combination to meet customer needs and automatically recommends other T-sap in accord with customer needs. The platform will enable interaction via multiple devices not limited to keyboard, fax, voice, pda, and cell phones. The platform will also enable collaboration for those who seek assistance through technology.

A Real Estate Investors critical pain points are better served specifically in a disaggregated manner through the Tiny Simple Applications. As the user wants to solve multiple pain points, the experience will be seamless as the systems will have multiple Tiny Simple Applications that have common data storage and common application model.

There is a need for a T-sap that guides real estate investors through accelerated depreciation by identifying short-life assets within their property and using market data gathered by the T-sap to help user value those assets. Using market data gathered by the T-sap to help user value those assets.

### Glossary of Terms

Browser: a software program that runs on a client host and is used to request Web pages and other data from server hosts. This data can be downloaded to the client's disk or displayed on the screen by the browser.

Client host: a computer that requests Web pages from server hosts, and generally communicates through a browser program.

Content provider: a person responsible for providing the information that makes up a collection of Web pages.

Embedded client software programs: software programs that comprise part of a Web site and that get downloaded into, and executed by, the browser.

Cookies: data blocks that are transmitted to a client browser by a web site.

Hit: the event of a browser requesting a single Web component.

Host: a computer that is connected to a network such as the Internet. Every host has a hostname (e.g., mypc.mycompany.com) and a numeric IP address (e.g., 123.104.35.12).

HTML (HyperText Markup Language): the language used to author Web Pages. In its raw form, HTML looks like normal text, interspersed with formatting commands. A browser's primary function is to read and render HTML.

HTTP (HyperText Transfer Protocol): protocol used between a browser and a Web server to exchange Web pages and other data over the Internet.

HyperText: text annotated with links to other Web pages (e.g., HTML).

IP (Internet Protocol): the communication protocol governing the Internet.

Server host: a computer on the Internet that hands out Web pages through a Web server program.

URL (Uniform Resource Locator): the address of a Web component or other data. The URL identifies the protocol used to communicate with the server host, the IP address of the server host, and the location of the requested data on the server host. For example, “http://www.lucent.com/work.html” specifies an HTTP connection with the server host www.lucent.com, from which is requested the Web page (HTML file) work.html.

UWU server: in connection with the present invention, a special Web server in charge of distributing statistics describing Web traffic.

Visit: a series of requests to a fixed Web server by a single person (through a browser), occurring contiguously in time.

Web master: the (typically, technically trained) person in charge of keeping a host server and Web server program running.

Web page: multimedia information on a Web site. A Web page is typically an HTML document comprising other Web components, such as images.

Web server: a software program running on a server host, for handing out Web pages.

Web site: a collection of Web pages residing on one or multiple server hosts and accessible through the same hostname (such as, for example, www.lucent.com).

### BRIEF DESCRIPTION OF THE DRAWINGS

Without restricting the full scope of this invention, the preferred form of this invention is illustrated in the following drawings:

FIG. 1 shows an overview of how a User accesses the system;

FIG. 2 shows the system on a User's computer;

FIG. 3 displays the central processing system and the Tiny Simple Applications;

FIG. 4 displays how the system searches for market prices;

FIG. 5 displays the depreciation screen with depreciation options; and

FIG. 6 displays a chart showing accelerated versus normal depreciation.

### BRIEF DESCRIPTION OF THE PREFERRED EMBODIMENTS

There are a number of significant design features and improvements incorporated within the invention.

The present invention relates to system 1 and a destination web platform 100 that will serve the needs of Real Estate investors in a unique way. The system will create and have Tiny Simple Applications (T-saps) that serve unique functions that solve the pain points of real estate investors. The current invention is an accelerated depreciation of separated assets with valuation guidance tiny simple application for the real estate web application platform.

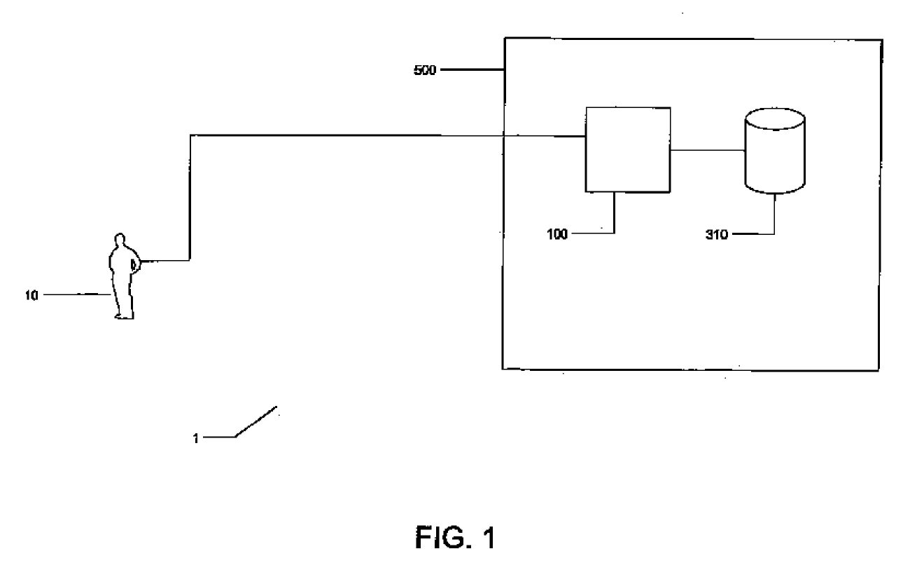

FIG. 1 illustrates a functional diagram of a computer network for World Wide Web 500 access to the System 1 from a plurality of Users 10 who accesses the system Web Site 100 or the Users 10 can connect directly to the System 1. Accessing the System Web Site 100 can be accomplished directly through a communication means such as a direct connection, an intranet, a local Internet Service Provider, often referred to as ISPs, or through an on-line service provider like CompuServe, Prodigy, American Online, etc. or Wireless devices using services like AT&T or Verizon. Each user 10 will have a display device such as a monitor and an input device like a keyboard. This display and input device can even be a PDA like a blackberry.

The Users 10 contact the System Web Site 100 using an informational processing system (Client) capable of running an HTML compliant Web browser such as Microsoft's Internet Explorer, Netscape Navigator, Lynx, Safari, and Mosaic. A typical system that is used is a personal computer with an operating system such as Windows 95, 98 or ME, NT, 2000, MacIntosh, or Linux, running a Web browser. The exact hardware configuration of computer used by the Users 10, the brand of operating system or the brand of Web browser configuration is unimportant to understand this present invention. Those skilled in the art can conclude that any HTML (Hyper Text Markup Language) compatible Web browser is within the true spirit of this invention and the scope of the claims. The User 10 can also access the system 1 through voice and E-mail, as well as any other standard or new form of communication.

In one preferred embodiment of the invention, the Users 10 connect to the System 1. The User 10 will typically be a real estate investor. The system 1 will have a database 310 for the storing of data and code.

The system 1 will enable different modes of input devices for interaction such as keyboard, touch-screen, fax, audio, cellphones, pda, etc. and will output information on appropriate displays such as video terminals, e-mail, fax, audio, cellphones etc.

Output can include a screen, a graphical user interface, hardcopy, facsimile, e-mail, messaging or other communication with any humanly or machine discernable data and/or artifacts. In some embodiments, output can include transmitting the risk variable related data to a designated recipient, any humanly or machine discernable data and/or artifacts.

The data processing system 1 for both embodiments includes computer processing means for processing data, storage means for storing data on a storage medium, and communication means for transferring data in a secure environment.

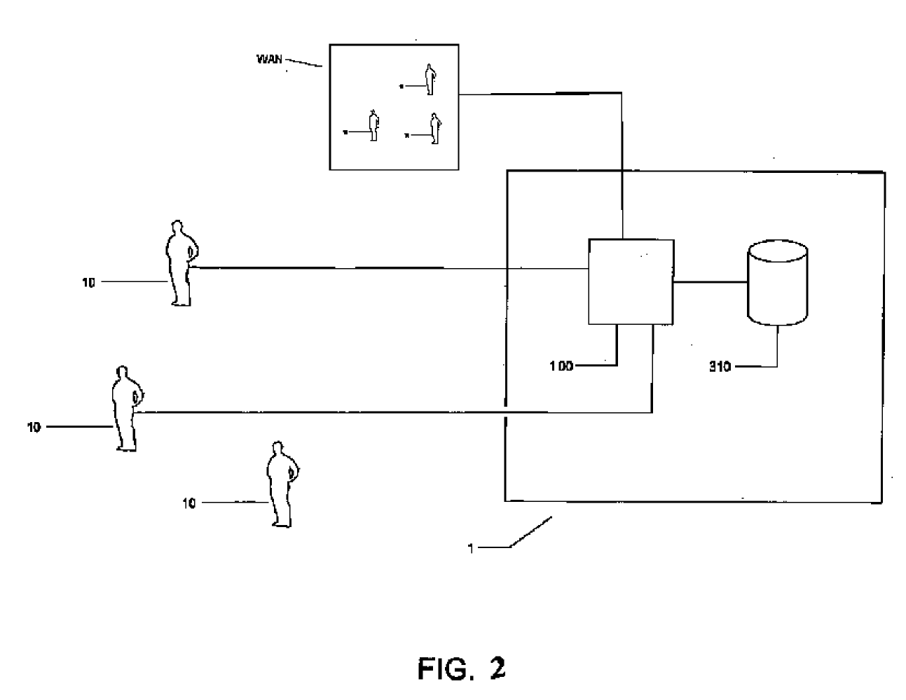

In another embodiment, the system 1 can be a stand alone system used by the user 10 loaded on the user's computer or server without the need to connect to the system 1 through the Internet. This embodiment can be connected to multiple Users 10 through a WAN connection as shown in FIG. 2.

The user 10 will log on to the system 1 using a username and password using generally accepted username and password rules. This username and password will be unique to the user 10.

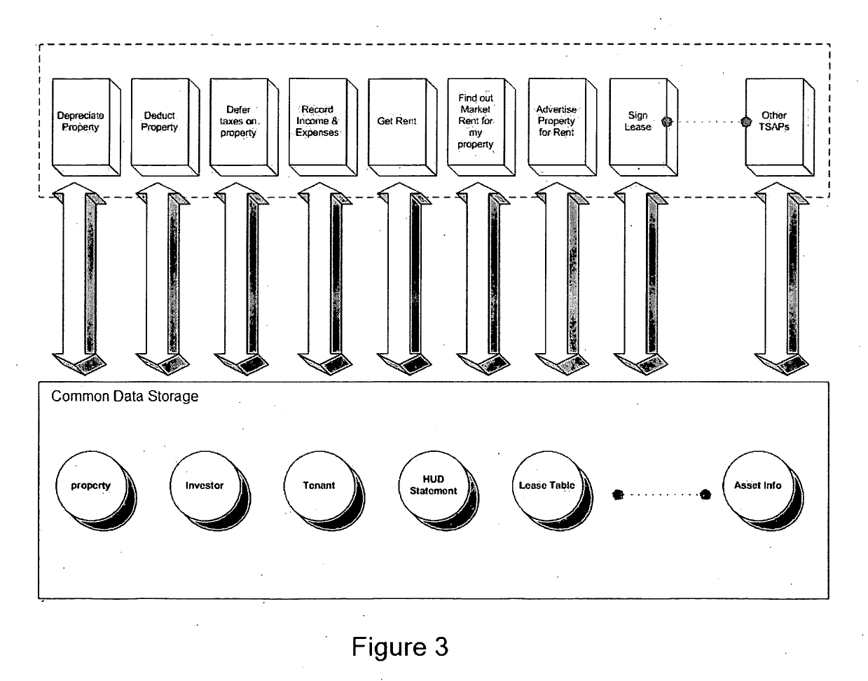

The system 1 is a central processing application 200 which will run system architecture, background and maintenance functions such as database 310 management, logon procedure, security functions and data input and output. The central processing application 20 will manage the running of the Tiny Simple Applications 210 as shown in FIG. 3.

The central processing application 200 automatically analyzes the data entered by a real estate investor and guides the investor to select the Tiny Simple Applications 210 that enables the real estate investor to maximize their return on investment.

The central processing application 200 creates a simple, seamless, and integrated experience with multiple Tiny Simple Applications 210. The central processing application 200 is selected intelligently based on the needs of the investor.

A Real Estate Investor's critical pain points are better served specifically in a disaggregated manner through the Tiny Simple Applications 210. As the user wants to solve multiple pain points, the experience will be seamless as the systems will have multiple Tiny Simple Applications that have common data storage 310 and central processing application 200.

A Tiny Simple Application 210 is an application that solves one need of a Real Estate Investor. An Example of a Tiny Simple Application 210 is an application that assists a Real Estate Investor with calculating accelerated depreciation calculation and automatically generating IRS Form 4562. A Tiny Simple Application 210 is designed to be simple and small. It solves one problem. It solves the situation and problem that is put in front of it for this functionality. It has inbuilt intelligence that guides investors to maximize their return. It will access the database 310 for all required information dealing with the problem being solved. It will also allow for the inputting of data needed for the solution of the problem and pass that data on to the central processing application 200 for storage to the database 310.

A Tiny Simple Application 210 can be executed in any order with other Tiny Simple Applications 210. It could be the only Tiny Simple Application executed or it could be one of many (in any sequence first, middle or last). It will give the user some suggestions on what to do next based on its context and findings.

The current invention is for a Tax Depreciation Allowance Tiny Simple Application 600 that will assist an investor with allowable depreciation. This is a Tax Saving web tool for a Real Estate investor. The Tax Depreciation Allowance Tiny Simple Application 600 allows for accelerated depreciation via cost segregation of asset in Real Estate investment.

It will use current market data via web technologies to assess the value of the assets by accessing market data via web technology and web market place to help guide user on assessing fair market value of their assets.

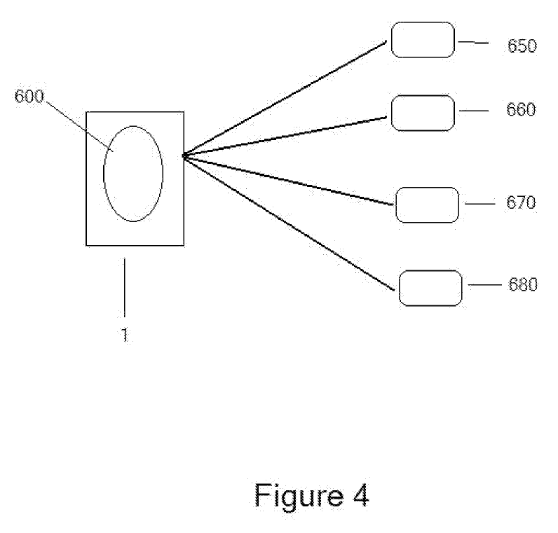

As shown in FIG. 4, the Tax Depreciation Allowance Tiny Simple Application 600 will automatically and dynamically search the internet to find market prices (FMV) of common assets found in rental properties. It will assess their quality and condition to come up with FMV evaluation database for the user. So the user 10 can enter kind of asset they have and asset based model, type, and quality, condition what are similar assets selling for or have sold for that type of asset. The system 1 will then do the search for the FMV. This allows the user 10 to make a proper FMV assessment of their asset which can be backed up with market data.

This is done in a dynamic fashion by Tax Depreciation Allowance Tiny Simple Application 600 in an automated way searching the Internet and key large marketplaces for their transaction history of all common assets used for rental property. The Tax Depreciation Allowance Tiny Simple Application 600 will search key large Marketplaces 650 as well as other method such as database search 660, catalog search 670 or other types of searches 680. The system will use electronic surveying of market data via online market places. This search is based on the asset kind of asset, model, type, and quality, condition as entered in by the User 10.

In the preferred Embodiment, the Tax Depreciation Allowance Tiny Simple Application 600 will provide data and receive data from some of the other Tiny Simple Applications 210 such as a Tenant Screener Application 220, which is a tool to help investors advertise, manage the flow of tenant applicants, evaluate potential tenant applicants, automated credit and other worthiness checks on potential tenants, and automated electronic leasing technology; a property performance manager 225, which is a bookkeeping solution specifically for the real estate investor; a Payment processor application 230, which is an automated electronic system for rent payment from tenant to landlord, payment to service providers; a properties listed application 235; a properties available application 240; and a Community application 245, which is a an online forum for the investors and associated specialist (Realtor, loan brokers, property managers, etc.) to dialogue and learn from each other. The system 1 will have other Tiny Simple Applications to solve other issues as well and will allow the development of new Tiny Simple Applications to address a Real Estate Investor's future and current issues and pain point. The system 1 will create a repository of properties for sale and acquisition and provide tools to help each investor make the right buy/sell decisions for their situation.

The system 1 including the central processing application and the tiny simple application can be written in any computer language that can perform the functions required. Each of the applications can be written in its own language so long as the applications can communicate and transfer data to each other properly. This adds to the flexibility of the system.

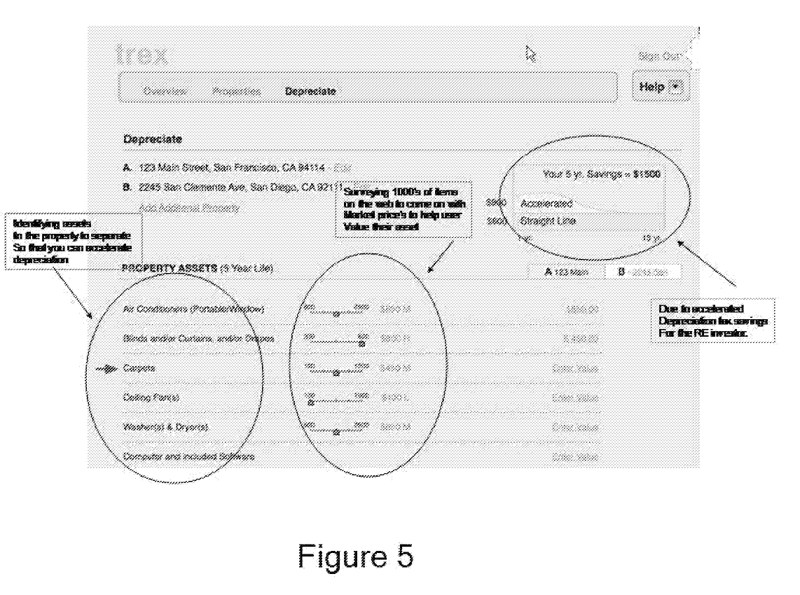

FIG. 5 displays a potential screen used with accelerated depreciation. The system 1 will be used in the identifying assets to be depreciated based and separated by the property. This will allow the user to use and see the effects of using accelerated depreciation versus straight-line depreciation on those assets. FIG. 5 shows two different properties and a listing of the assets in each of those properties.

The system 1 surveys 1000's of items on the web to come up with Market prices to help user value their assets. The system 1 will provide the user 10 with suggested new and used dollar values. The user 10 will input the dollar value of the asset to be depreciated in an input value field on the screen. The user 10 will do this for all of the listed assets.

The system 1 will provide a default set of listed assets based on common assets in a real estate investment. The system 1 will also allow the User 10 to add additional assets based on the property.

The assets will be separated into Property Assets with a 5 year life for depreciation purposes and Land Improvements with a 15 Year Life for depreciation purposes, or according to appropriate depreciation schedules. The assets will be grouped into their proper depreciation life by years.

Property Assets are assets like Air Conditioners (Portable/Window), Blinds and/or Curtains, and/or Drapes, Carpets, Ceiling Fan(s), Washer(s) & Dryer(s), Computer and included Software, Office Equipment (Calculators, copiers, Fax Machines), Dishwasher(s), Fire Extinguisher(s), Garbage Disposal(s), Kitchen Cooktop(s)/Range(s)/Stove(s), Microwave Oven(s), Kitchen Oven(s) and Water Heater(s). The user 10 will be able to input additional Property Assets by inputting the name of the asset, the life of the product and the service date.

Land Improvements are things that go with the land such as Driveways, Fences (Permanent), landscaping, Patio Area(s) and Paved Parking Area(s). The user 10 will be able to input additional Land Improvements by inputting the name of the asset, the life of the product and the service date.

The user 10 can also input additional assets by inputting the name of the asset, the life of the product and the service date.

The user 10 will also input the land value as specified in tax information. The system 1 can also find the land value as inputted for other Tiny Simple Applications 210 or do a web base or database search to retrieve the information.

The system 1 will add all of the assets entered into the Tax Depreciation Allowance Tiny Simple Application 600 into a sum of assets. The system 1 will also have the ability to calculate subsets of the assets based on their depreciation life and schedule.

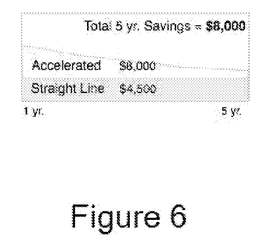

The system 1 will display the total savings based on a number of years based on using accelerated depreciation versus straight line depreciation. This is shown in FIG. 6.

### Advantages

The system is designed to provide tools to help manage investment property and maximize their returns. It is designed to create a destination for small real estate investors to learn from each other. It will create repository of properties for sale and acquisition appropriate to small real estate investor, with tools to help each investor make right buy/sell decisions for their situation.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A real estate investor system comprising: having an accelerated depreciation of separated assets with value guidance central processing application and having a plurality of tiny simple applications which communicate with the central processing application.

2. A system according to claim 1 where the system has a list of assets to be depreciated.

3. A system according to claim 2 where the system will look up the value of said assets.

4. A system according to claim 3 where the system will look up the value of said assets using electronic surveying of market data via online market places.

5. A system according to claim 2 where the assets are grouped by depreciation term.

6. A system according to claim 2 where the system will do a comparison between accelerated and straight line depreciation.

7. A system according to claim 1 where a plurality of properties can be entered.

8. A system according to claim 1 where a user can add additional assets.

9. The system according to claim 1 wherein said system is accessed through the Internet.

10. A real estate investor system comprising: having an accelerated depreciation of separated assets with valuation guidance tiny simple applications communicates with a central processing application and having a plurality of other tiny simple applications that communicate with the central processing application.

11. A system according to claim 10 where the system has a list of assets to be depreciated.

12. A system according to claim 11 where the system will look up the value of said assets.

13. A system according to claim 11 where the assets are grouped by depreciation term.

14. A system according to claim 11 where the system will do a comparison between accelerated and straight line depreciation.

15. A system according to claim 11 where a plurality of properties can be entered.

16. A system according to claim 11 where a user can add additional assets.

17. A system according to claim 12 where the system will look up the value of said assets using electronic surveying of market data via online market places.

18. The system according to claim 11 where each of said tiny simple applications will be able to use data collected by other tiny simple applications that have been execute prior to its execution.

19. The system according to claim 11 where said system also collaboration between real estate investors.

20. The system according to claim 11 where a plurality of tiny simple applications can be executed independently and can be executed any order.
